(19) United States
(12) Patent Application Publication
(10) Pub. No.: US 2020/0364698 A1
(43) Pub. Date: Nov. 19, 2020

(54) METHOD AND SYSTEM FOR FACILITATING TRANSACTIONS

(71) Applicant: MASTERCARD INTERNATIONAL INCORPORATED, Purchase, NY (US)

(72) Inventors: Raju Kumar GUPTA, Pune (IN); Rajeev Kumar, Varanasi (IN)

(73) Assignee: MASTERCARD INTERNATIONAL INCORPORATED, Purchase, NY (US)

(21) Appl. No.: 16/842,326

(22) Filed: Apr. 7, 2020

(30) Foreign Application Priority Data
May 15, 2019 (SG) 10201904387P

(51) Int. Cl. G06Q 20/36; G06Q 20/40

(52) U.S. Cl. CPC G06Q 20/3674; G06Q 20/401

(57) ABSTRACT

A method and a system for facilitating transactions are provided. A first payment mode is linked to one or more payment modes by a server. A first authorization option presented on a graphical interface of a terminal device enables a user to initiate a transaction using the first payment mode. One or more unique identifiers of the one or more payment modes, respectively, are communicated to the terminal device by the server based on a transaction request of the transaction. A first unique identifier, associated with a second payment mode that is linked to the first payment mode, is selected from the one or more unique identifiers. A selection notification indicating the selection of the first unique identifier is received by the server and a transaction amount of the transaction is charged to the second payment mode, when the transaction is authorized.

### CROSS-REFERENCE TO RELATED APPLICATIONS

This application claims priority to Singaporean Application Serial No. 10201904387P, filed May 15, 2019, which is incorporated herein by reference in its entirety.

### FIELD OF THE INVENTION

Various embodiments of the present invention relate generally to transaction processing systems. More specifically, various embodiments of the present invention relate to a method and a system for facilitating transactions.

### BACKGROUND

Digitization has led to an emergence of payment platforms that enable users to perform hassle free financial transactions. Examples of such payment platforms include automatic teller machines (ATMs), point-of-sale (POS) devices, online payment gateways, or the like. Typically, these payment platforms require a payment account, a transaction card, a digital wallet, or an application for performing the financial transactions. In one example, a user, who has to withdraw cash from her payment account at an ATM, either requires a transaction card which is linked to the payment account or a mobile device linked to a registered contact number of the payment account. In another example, a user, who has to purchase a product from a merchant store, requires cash that is equivalent to the price of the product, a transaction card linked to her payment account, or a smartphone having a digital wallet application executed thereon to pay for the product.

In certain scenarios, the user may be accompanying an acquaintance (for example, a friend, a family member, a colleague, or the like) to a merchant store for shopping and may not be carrying any cash, her transaction card, or her mobile device. In such scenarios, the user may not be able to purchase any desired product from the merchant store, unless the acquaintance pays for the product. However, if the acquaintance does not have sufficient cash or money in her transaction card or her digital wallet to purchase the product for the user, the user may not be able to purchase the desired product and may be inconvenienced.

In light of foregoing, there exists a need for a solution that allows a user to perform a transaction even when the user is not carrying a corresponding transaction card and a corresponding mobile device.

### SUMMARY

In an embodiment of the present invention, a method for facilitating transactions is provided. The method includes linking, by a server, a first payment mode to one or more payment modes. A transaction request for a transaction is received by the server. The transaction is initiated by way of the first payment mode. Based on the transaction request, one or more unique identifiers of the one or more payment modes, respectively, are communicated to the terminal device by the server. A selection notification indicating a selection of a first unique identifier of the one or more unique identifiers is received by the server. The first unique identifier is associated with a second payment mode that is linked to the first payment mode. Based on the received selection notification, an authorization of the transaction is initiated by the server. A transaction amount of the transaction is charged to the second payment mode when the transaction is authorized.

In another embodiment of the present invention, a system for facilitating transactions is provided. The system includes a server that links a first payment mode to one or more payment modes. The server receives a transaction request for a transaction that is initiated by way of the first payment mode from a terminal device. Based on the transaction request, the server communicates one or more unique identifiers of the one or more payment modes, respectively, to the terminal device. The server receives a selection notification indicating a selection of a first unique identifier of the one or more unique identifiers from the terminal device. The first unique identifier is associated with a second payment mode that is linked to the first payment mode. Based on the received selection notification, the server initiates an authorization of the transaction. A transaction amount of the transaction is charged to the second payment mode when the transaction is authorized.

In another embodiment of the present invention, a method for facilitating transactions is provided. The method includes rendering a graphical interface, by a terminal device, for presenting a first authorization option to a user. The first authorization option is indicative of initiating a transaction by way of a first payment mode and charging a transaction amount of the transaction to a different payment mode that is linked to the first payment mode. Based on a selection of the first authorization option, a transaction request for the transaction is communicated to a server. The transaction is initiated by way of the first payment mode. One or more unique identifiers of one or more payment modes are received by the terminal device from the server. The one or more payment modes are linked to the first payment mode. The one or more unique identifiers are presented on the rendered graphical interface by the terminal device for selection. A selection notification indicating a selection of a first unique identifier of the one or more unique identifiers is communicated to the server by the terminal device. The first unique identifier is associated with the second payment mode and the transaction amount of the transaction is charged to the second payment mode when the transaction is authorized.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present invention are illustrated by way of example, and not limited by the appended figures, in which like references indicate similar elements:

FIG. 1 is a block diagram that illustrates an exemplary environment for facilitating transactions, in accordance with an embodiment of the present invention;

FIG. 2 is a process flow diagram that illustrates an exemplary scenario for registering users with a value-added service (VAS) server of FIG. 1, in accordance with an embodiment of the present invention;

FIGS. 3A and 3B are Tables that illustrate exemplary databases maintained at the VAS server of FIG. 1, in accordance with an embodiment of the present invention;

FIG. 4 is a process flow diagram that illustrates an exemplary scenario for facilitating transactions, in accordance with an embodiment of the present invention;

FIG. 5 is an exemplary scenario that illustrates user interface (UI) screens rendered on the terminal device for enabling users to initiate transactions and avail a value-added service offered by the VAS server, in accordance with an embodiment of the present invention;

FIG. 6 is a block diagram that illustrates the VAS server of FIG. 1, in accordance with an embodiment of the present invention;

FIG. 7 is a block diagram that illustrates a terminal device of FIG. 1, in accordance with an embodiment of the present invention;

FIG. 8 is a block diagram that illustrates an acquirer server of FIG. 1, in accordance with an embodiment of the present invention;

FIG. 9 is a block diagram that illustrates a payment network server of FIG. 1, in accordance with an embodiment of the present invention;

FIG. 10 is a block diagram that illustrates an issuer server of FIG. 1, in accordance with an embodiment of the present invention;

FIG. 11 represents a flow chart that illustrates a method for registering users with the VAS server of FIG. 1, in accordance with an embodiment of the present invention;

FIG. 12 represents a flow chart that illustrates a method for facilitating transactions by the VAS server of FIG. 1, in accordance with an embodiment of the present invention;

FIG. 13 represents a flow chart that illustrates a method for facilitating transactions by the terminal device of FIG. 1, in accordance with an embodiment of the present invention;

FIG. 14 represents a high-level flow chart that illustrates a method for facilitating transactions, in accordance with an embodiment of the present invention;

FIG. 15 represents a high-level flow chart that illustrates a method for facilitating transactions, in accordance with an embodiment of the present invention; and

FIG. 16 is a block diagram that illustrates system architecture of a computer system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### OVERVIEW

A user, accompanying an acquaintance for shopping, may not carry any cash, her transaction card, or her mobile device. Thus, the user may not be able to purchase any desired product unless the acquaintance pays for the product on behalf of the user. However, if the acquaintance does not have sufficient cash or money in the transaction card to purchase the product on user's behalf, the user may not be able to purchase the product and may be inconvenienced.

Various embodiments of the present invention provide a method and a system that solve the abovementioned problems by offering a value-added service that allows a user to perform transactions in absence of user's payment mode (for example, user's transaction card and user's digital wallet). An acquaintance of the user, who has already registered her payment mode for the value-added service, may add the user to a list of trusted members of the acquaintance and link the payment mode of the user to the payment mode of the acquaintance. A server, offering the value-added service, maintains the list of trusted members of the acquaintance and details of all payment modes that are linked to the acquaintance's payment mode. After the user's payment mode is linked to the acquaintance's payment mode, the acquaintance's payment mode may be used for initiating a transaction at a terminal device, e.g., an automatic teller machine (ATM) or a point-of-sale (POS), on behalf of the user, and the user's payment mode may be charged with a transaction amount of the transaction. When the acquaintance's payment mode is used for initiating the transaction, the terminal device communicates with the server and receives unique identifiers associated with all trusted members of the acquaintance from the server. Since the transaction is initiated on behalf of the user, the user selects a first unique identifier that corresponds to the user from the received unique identifiers, and provides a first authentication parameter of the user's payment mode. The terminal device communicates a selection notification to the server indicating that the first unique identifier is selected. The selection notification includes an authentication parameter provided by the user. Based on the selection notification, the server selects the user's payment mode for processing the transaction and authenticates the user based on the authentication parameter included in the selection notification. When the user is successfully authenticated, the server generates an authorization request for the transaction and communicates the authorization request to an issuer of the user's payment mode. The authorization request includes details of the user's payment mode. The issuer authorizes the transaction based on the authorization request. Since the authorization request is generated based on the details of the user's payment mode, the user's payment mode is charged with the transaction amount of the transaction when the transaction is authorized. Thus, by way of the value-added service, the user is enabled to perform the transaction even in the absence of the corresponding payment mode and without requiring the acquaintance to pay for the transaction.

### Terms Description (in Addition to Plain and Dictionary Meaning)

Transaction is an exchange of funds between two or more parties. For example, the transaction may include transferring a transaction amount from a user to a merchant, when the user makes a purchase from the merchant. In another example, the transaction may include dispensing cash, at an ATM, equivalent to a transaction amount debited from an account of the user based on a request from the user.

Payment mode is a means of payment, such as a debit card, a credit card, a prepaid card, a gift card, a promotional card, a contactless card, a digital wallet, and/or like, that is linked to an account and holds identification information of the account. The payment mode may be used to perform transactions, such as deposits and cash-withdrawals, credit transfers, purchase payments, or the like, from the account to which it is linked. The payment mode may be a physical payment mode or a virtual payment mode that is electronically stored in a user device.

Terminal device is a computing device affiliated with a financial institution, (hereinafter “acquirer”). The terminal device enables users to perform various electronic transactions, such as cash withdrawals, cash deposits, purchase payments, funds transfer, or the like. Examples of the terminal device include, but are not limited to, a POS device, a point-of-purchase (POP), a point-of-interaction (POI), an ATM, a bunch note acceptor (BNA), a currency recycler, or the like.

Acquirer is a financial institution where accounts of several merchants are established and maintained. The acquirer is further associated with a terminal device. The acquirer communicates an authorization request for a transaction performed at the terminal device to a payment network.

Authorization request for a transaction refers to a request by which an acquirer ensures that the transaction is valid and authorized by a corresponding issuer. The acquirer communicates the authorization request to the issuer for authorization. The authorization request is pursuant to one or more standards for the interchange of transaction messages, such as the ISO8583 standard, and includes various fields, such as data elements (DEs), for storing transaction details of the transaction.

Authorization response is a response generated by an issuer for an authorization request corresponding to a transaction. The issuer generates the authorization response to indicate whether the transaction is authorized. The authorization response is pursuant to one or more standards for the interchange of transaction messages, such as the ISO8583 standard, and includes various data fields, such as DEs, for storing transaction details of the transaction.

A trusted member is an individual who is known to a user. The trusted member may be a friend, a family member, a relative, or any other individual whom the user trusts. Based on an invitation from the user, the trusted member links a payment mode of the trusted member to a payment mode of the user.

A unique identifier is a code that uniquely identifies a trusted member's payment mode that is linked to a user's payment mode. The unique identifier is stored in a memory. The unique identifier may be a name, a number, an alphanumeric code, or a combination of alphanumeric and special characters by way of which the user may uniquely identify the trusted member's payment mode. For example, John Doe, 87563, John123, or John@123#.

First authorization option is a transaction option displayed on a graphical interface rendered by a terminal device. When a user selects the first authorization option for performing a transaction, the user is able initiate the transaction by way of a first payment mode and a transaction amount of the transaction is charged to a different payment mode linked to the first payment mode.

Server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of a value-added service server, an acquirer server, a payment network server, an issuer server, or a third-party server.

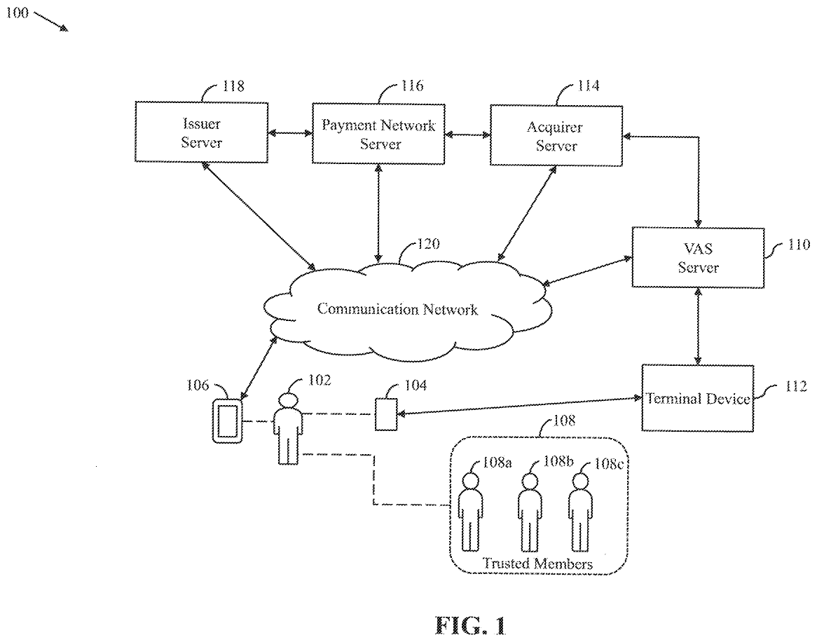

FIG. 1 is a block diagram that illustrates an exemplary environment 100 for facilitating transactions, in accordance with an embodiment of the present invention. The environment 100 includes a user 102 in possession of a first transaction card 104 and a user device 106. The environment 100 further includes first through third trusted members 108a-108c (hereinafter, referred to as “the trusted members 108”), a value-added service (VAS) server 110, a terminal device 112, an acquirer server 114, a payment network server 116, and an issuer server 118. The VAS server 110, the terminal device 112, the acquirer server 114, the payment network server 116, and the issuer server 118 communicate with each other by way of a communication network 120 or through separate communication networks established therebetween.

The user 102 is an individual, who is an account holder of a user account maintained at a financial institution, such as an issuer. The issuer may have issued the first transaction card 104 to the user 102 for performing transactions from the user account. The first transaction card 104 is linked to the user account and stores identification information of the user account (hereinafter, referred to as “account information” of the user account) in the form of an electronic chip. The account information may include an account number, a name of an account holder (i.e., the user 102), or the like. The first transaction card 104 has a unique card number, an expiry date, a card security code, and a card type associated with it. The unique card number, the expiry date, the card security code, and the card type are collectively referred to as card details of the first transaction card 104. In one embodiment, the first transaction card 104 is a physical card used for performing the transactions at the terminal device 112. In another embodiment, the first transaction card 104 is a virtual card stored in a memory (not shown) of the user device 106. Examples of the first transaction card 104 include a credit card, a debit card, a membership card, a promotional card, a charge card, a prepaid card, a gift card, or the like. In one embodiment, the user 102 may be a registered member of a digital wallet service and may have a first digital wallet. The first transaction card 104 and the first digital wallet correspond to payment modes of the user 102.

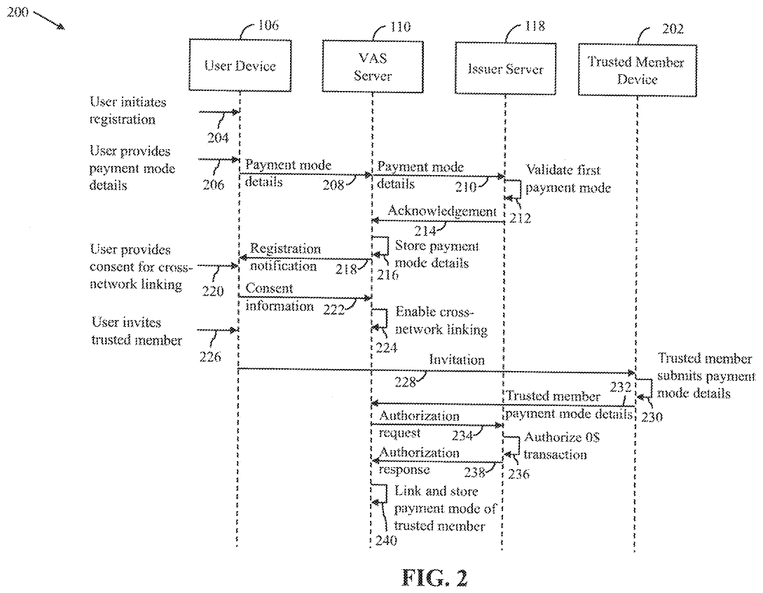

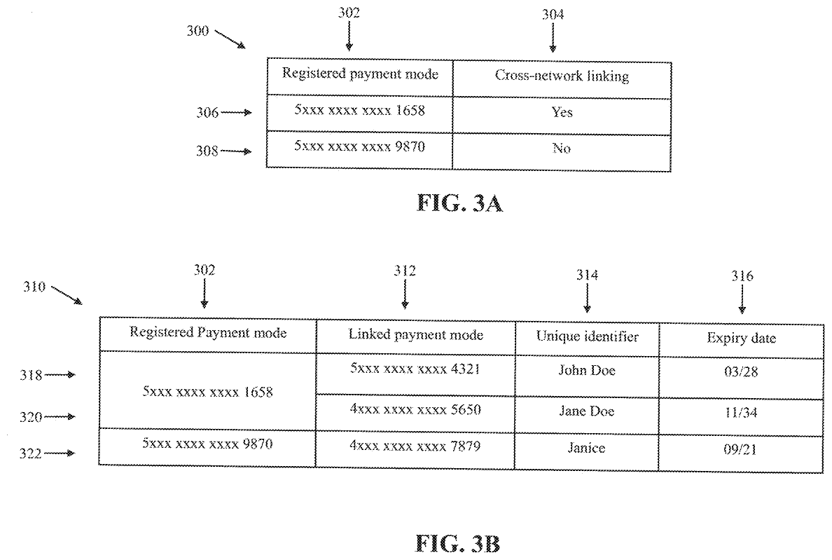

The user device 106 is a communication device of the user 102. The user device 106 may serve as an interface for the user 102 to register with the VAS server 110 for availing a value-added service offered by the VAS server 110. The user 102 may register a first payment mode (e.g., the first transaction card 104 or the first digital wallet) of the user 102 for the value-added service. In one embodiment, the user device 106 may have an application running thereon. The service application may be hosted by the VAS server 110 and responsible for providing an option to the user 102 to register the first payment mode for the value-added service offered by the VAS server 110. The registration of the user 102 with the VAS server 110 is described in detail in conjunction with FIGS. 2, 3A, and 3B.

After the user 102 has successfully registered the first payment mode, the user 102 may utilize the user device 106 for inviting the trusted members 108 to link their payment modes to the first payment mode (e.g., the first transaction card 104 or the first digital wallet) of the user 102. For inviting the trusted members 108, the user 102 may utilize the user device 106 to communicate invitations to trusted member devices (not shown) of the trusted members 108. Examples of the user device 106 may include, but are not limited to, a mobile phone, a smartphone, a laptop, a tablet, a phablet, or any other device capable of communicating via the communication network 120.

The trusted members 108 are individuals who are known to the user 102. Examples of the trusted members 108 may include, but are not limited to, family members, friends, colleagues, or the like of the user 102. The trusted members 108 may receive the invitations from the user 102 through the trusted member devices. The trusted members 108 may choose to accept or decline the invitations. For example, the first and second trusted members 108a and 108b may accept the invitations from the user 102, while the third trusted member 108c may decline the invitation. After accepting the invitations, the first and second trusted members 108a and 108b may provide details of respective payment modes (for example, transaction cards and/or digital wallets) to the VAS server 110 for linking their respective payment modes to the first payment mode of the user 102. When a second payment mode (e.g., a second transaction card and/or a second digital wallet) of the first trusted member 108a is linked to the first payment mode, the user 102 may initiate transactions on behalf of the first trusted member 108a by using the first payment mode. In such a scenario, the second payment mode is charged with transaction amounts of the transactions. Likewise, when a third payment mode (e.g., a third transaction card or a third digital wallet) of the second trusted member 108b is linked to the first payment mode, the user 102 may initiate transactions on behalf of the second trusted member 108b by using the first payment mode. In such a scenario, the third payment mode of the second trusted member 108b is charged with transaction amounts of the transactions.

The VAS server 110 is a computing server that includes suitable logic, circuitry, interfaces, and/or codes, executed by the circuitry, for offering the value-added service. The VAS server 110 may offer the value-added service by hosting the service application that is executable on the user device 106. The VAS server 110 may register the first payment mode of the user 102 for the value-added service based on a registration request initiated by the user 102. A user who has registered her payment mode for the value-added service is referred to as a registered user. The VAS server 110 may further allow the registered user 102 to invite various trusted members (for example, the trusted members 108) to link their corresponding payment modes with the first payment mode. The VAS server 110 may receive payment mode details of the payment modes of the trusted members 108 who accept the invitation of the user 102 and link the payment modes of those trusted members 108 to the first payment mode. For example, the VAS server 110 receives the payment mode details of the second and the third payment modes of the first and second trusted members 108a and 108b, respectively. The VAS server 110 may then store, in the memory of the VAS server 110, the payment mode details of the linked payment modes of the trusted members 108 in an encrypted format. The VAS server 110 may further associate each of the linked payment modes with a unique identifier.

When the user 102 has registered the first payment mode for the value-added service, the user 102 may initiate transactions at the terminal device 112 on behalf of the trusted members 108 by using the first payment mode. In one exemplary scenario, the user 102 may initiate a transaction at the terminal device 112 on behalf of the first trusted member 108a by using the first transaction card 104. In such a scenario, the VAS server 110 receives a transaction request including transaction details of the transaction from the terminal device 112 and determines whether the first transaction card 104 used for initiating the transaction is registered for the value-added service. When the first transaction card 104 is determined to be registered for the value-added service, the VAS server 110 retrieves the unique identifiers associated with the payment modes that are linked to the first transaction card 104 and communicates the retrieved unique identifiers to the terminal device 112. As the transaction is initiated on behalf of the first trusted member 108a, the first trusted member 108a may select a first unique identifier that corresponds to the second payment mode of the first trusted member 108a. The VAS server 110 further receives a selection notification from the terminal device 112 indicating the selection of the first unique identifier. The selection notification may further include an authentication parameter associated with the second payment mode. The VAS server 110 may validate the second authentication parameter and generate the authorization request based on the validation of the second authentication parameter. In one example, the authorization request is a message pursuant to one or more standards for the interchange of transaction messages, such as the ISO8583 standard. The VAS server 110 may further communicate the authorization request to the acquirer server 114 for authorizing the transaction. If the transaction is authorized, the second payment mode of the first trusted member 108a is charged with the transaction amount of the transaction.

The terminal device 112 includes suitable logic, circuitry, interfaces, and/or codes, executed by the circuitry, to allow users (such as the user 102 and the trusted members 108) to perform transactions from corresponding user accounts. The terminal device 112 may be associated with a financial institution, such as an acquirer. Examples of the terminal device 112 include an ATM, a BNA, a currency recycler, a POP device, a POI device, a POS device, or the like. The terminal device 112 may render a graphical interface to present first and second authorization options to the user 102. The first authorization option is associated with the value-added service offered by the VAS server 110 and enables the user 102 to initiate transactions on behalf of the trusted members 108. When the first authorization option is selected for performing a transaction, the terminal device 112 communicates the transaction request for the transaction to the VAS server 110. The terminal device 112 then receives unique identifiers of various payment modes that are linked to a payment mode using which the transaction was initiated. The terminal device 112 displays the received unique identifiers on the graphical interface. The terminal device 112 further communicates the selection notification to the VAS server 110 indicating a selection of one of the received unique identifiers. The terminal device 112 further receives an authorization response from the acquirer server 114 based on the authorization of the transaction. The terminal device 112 may further display a message, on the graphical interface, indicating whether the transaction is approved or declined. The second authorization option refers to conventional authorization in which the payment mode used for initiating a transaction is charged with a transaction amount of the transaction. For example, if the user 102 selects the second authorization option and initiates a transaction using the first transaction card 104, the transaction amount of the transaction is charged to the first transaction card 104.

The acquirer server 114 is a computing server that is operated by the acquirer and includes suitable logic, circuitry, interfaces, and/or codes, executed by the circuitry, for processing the transactions. The acquirer server 114 may receive authorization requests from the VAS server 110 and the terminal device 112, and may communicate the authorization requests to relevant payment networks (for example, the payment network server 116) for further processing of the transaction.

The payment network server 116 is a computing server that is operated by a payment network and includes suitable logic, circuitry, interfaces, and/or codes, executed by the circuitry, for processing transactions. The payment network server 116 represents an intermediate entity between the acquirer server 114 and the issuer server 118 for authorizing and funding the transactions performed by way of transaction cards, for example the second transaction card. The payment network server 116 may receive the authorization requests from various acquirer servers (for example, the acquirer server 114) and communicate the authorization requests to relevant issuers (for example, the issuer server 118).

The issuer server 118 is a computing server that is operated by the issuer and includes suitable logic, circuitry, interfaces, and/or codes, executed by the circuitry, for processing transactions. The issuer is a financial institution that manages accounts of multiple users, such as the user 102 and the trusted members 108. Account details of the accounts established with the issuer are stored as account profiles in a memory (not shown) of the issuer server 118 or on a cloud server associated with the issuer server 118. The account details may include an account balance, an available credit line, details of an account holder, transaction history of the account holder, account information, or the like. The details of the account holder may include name, age, gender, physical attributes, registered contact number, alternate contact number, registered e-mail ID, or the like of the account holder. The issuer server 118 may receive various authorization requests from various payment networks (for example, the payment network server 116). The issuer server 118 authorizes the transactions based on the authorization requests and generates authorization responses indicating whether the transactions are approved or declined. Methods for processing transactions via the issuer server 118 will be apparent to a person having ordinary skill in the art and may include processing the transaction via the traditional four-party system or the traditional three-party system.

In one embodiment, the VAS server 110 may request the issuer server 118 to validate the payment modes of the trusted members 108 that are to be linked to the first payment mode of the user 102. For example, the VAS server 110 may generate and communicate authorization requests for $0 transactions from the payment modes that are to be linked to the first payment mode. When the payment modes that are to be linked to the first payment mode are valid, the issuer server 118 may authorize the $0 transactions and communicate authorization responses indicating the approval of the $0 transactions.

Examples of the VAS server 110, the acquirer server 114, the payment network server 116, and the issuer server 118 may include, but are not limited to, computers, laptops, mini-computers, mainframe computers, any non-transient and tangible machines that can execute a machine-readable code, cloud-based servers, distributed server networks, a network of computer systems, or a combination thereof.

Though the VAS server 110 is shown to be a standalone entity in FIG. 1, in other embodiments, the VAS server 110 may be integrated with any of the acquirer server 114, the payment network server 116, the issuer server 118, or any other third-party server, without deviating from the scope of the invention. For example, if the VAS server 110 is integrated with the payment network server 116, the functionality of the VAS server 110 may be implemented by the payment network server 116. In another example, if the VAS server 110 is integrated with the acquirer server 114, the functionality of the VAS server 110 may be implemented by the acquirer server 114. In another example, if the VAS server 110 is integrated with the issuer server 118, the functionality of the VAS server 110 may be implemented by the issuer server 118.

The communication network 120 is a medium through which content and messages are transmitted between the user device 106, the VAS server 110, the terminal device 112, the acquirer server 114, the payment network server 116, the issuer server 118, or other entities that are pursuant to one or more standards for the interchange of transaction messages, such as the ISO8583 standard. Examples of the communication network 120 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 120 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIG. 2 is a process flow diagram 200 that illustrates an exemplary scenario for registering users with the VAS server 110, in accordance with an embodiment of the present invention. The process flow diagram 200 involves the user device 106, the VAS server 110, and the issuer server 118. The process flow diagram 200 further involves a trusted member device 202 of the first trusted member 108a. The trusted member device 202 is functionally similar to the user device 106.

The value-added service provided by the VAS server 110 allows the users (for example, the user 102) to initiate the transactions on behalf of their trusted members (for example, the trusted members 108). For availing the value-added service, the user 102 is required to be registered with the VAS server 110. For registering with the VAS server 110, the user 102 initiates the registration process by accessing the service application running or is executed on the user device 106 (as shown by arrow 204). The user 102 provides payment mode details of the first payment mode through the user device 106 (as shown by arrow 206). In one example, when the first payment mode is the first transaction card 104, the user 102 provides the card details of the first transaction card 104. In another example, when the first payment mode is the first digital wallet, the user 102 provides the wallet details (such as a wallet ID) of the first digital wallet.

The user device 106 communicates the payment mode details of the first payment mode to the VAS server 110 (as shown by arrow 208). Based on the received payment mode details, the VAS server 110 identifies an issuer associated with the first payment mode of the user 102. For example, when the first payment mode is the first transaction card 104, the VAS server 110 identifies that the first transaction card 104 is associated with the issuer server 118. In another example, when the first payment mode is the first digital wallet, the VAS server 110 identifies that the first digital wallet is associated with a wallet issuer. In a non-limiting example, it is assumed that the first payment mode is the first transaction card 104.

The VAS server 110 further communicates the payment mode details of the first transaction card 104 to the issuer server 118 for validation (as shown by arrow 210). The issuer server 118 receives the payment mode details from the VAS server 110 and validates the first transaction card 104, i.e., the first payment mode, (as shown by arrow 212). In one exemplary scenario, the issuer server 118 may determine that the first transaction card 104 is invalid based on the payment mode details provided by the user 102. In such a scenario, the issuer server 118 communicates an acknowledgement to the VAS server 110 indicating that the first transaction card 104 is invalid. Based on the acknowledgement, the VAS server 110 requests the user 102, by way of the service application that runs on the user device 106, to either resubmit the payment mode details of the first transaction card 104 or to submit payment mode details of another payment mode (for example, another transaction card or the first digital wallet). In another exemplary scenario, when the first transaction card 104 is identified to be valid, the issuer server 118 communicates an acknowledgement to the VAS server 110 indicating that the first transaction card 104 is valid (as shown by arrow 214). The VAS server 110 receives the acknowledgement and stores the payment mode details of the first payment mode in the memory of the VAS server 110 (as shown by arrow 216). Likewise, the VAS server 110 validates payment modes of other users who want to avail the value-added service offered by the VAS server 110.

The VAS server 110 then communicates a registration notification to the user device 106 indicating a successful registration of the first payment mode for the value-added service (as shown by arrow 218). In other words, the registration notification indicates that the user 102 is successfully registered with the VAS server 110. The user device 106 receives the registration notification and displays an option to the user 102 for providing user's consent for cross-network linking of the first transaction card 104. Cross-network linking enables a payment mode associated with a first payment network to be linked with another payment mode that is associated with a different payment network. In one exemplary scenario, the user 102 may provide consent for cross-network linking by using the user device 106. In another exemplary scenario, the user 102 may not provide consent for cross-network linking. For the sake of ongoing description, it is assumed that the user 102 provides consent for cross-network linking of the first transaction card 104 by using the user device 106 (as shown by arrow 220). The user device 106 then communicates consent information to the VAS server 110 indicating that the user 102 has agreed for cross-network linking of the first transaction card 104 (as shown by arrow 222). The VAS server 110 receives the consent information and enables cross-network linking for the first transaction card 104 (as shown by arrow 224). The VAS server 110 may further store the consent information in the memory of the VAS server 110. In one exemplary scenario, the VAS server 110 may store the payment mode details of all payment modes that are registered with the VAS server 110 in the form of a tabular database (for example, a first database 300 of FIG. 3A). The database may further indicate whether cross-network linking is enabled or disabled for the registered payment modes.

With reference to FIG. 3A, a Table that illustrates the first database 300 maintained at the VAS server 110, in accordance with an embodiment of the present invention is shown. The first database 300 stores the payment mode details of the registered payment modes. The first database 300 includes a registered payment mode column 302 and a cross-network linking column 304. The registered payment mode column 302 stores the payment mode details of the registered payment modes in an encrypted format. For example, the registered payment mode column 302 may store transaction card numbers of registered transaction cards or wallet ids of registered digital wallets in an encrypted format. The cross-network linking column 304 indicates whether cross-network linking is enabled on a registered payment mode of the registered payment mode column 302. The first database 300 is shown to include first and second rows 306 and 308 for storing payment mode details of two registered payment modes.

In one exemplary scenario, the first row 306 includes the payment mode details (e.g., 5xxxxxxxxxxx1658) of the first transaction card 104. Since the user 102 has provided consent for the cross-network linking, the cross-network linking column 304 for the first row 306 indicates “Yes”. The second row 308 includes the payment mode details (e.g., 5xxxxxxxxxxx9870) of a registered payment mode of another user. The other user may have not provided consent for the cross-network linking, thus the cross-network linking column 304 for the second row 308 indicates “No”.

Referring back to FIG. 2, after the user 102 is successfully registered with the VAS server 110 for availing the value-added service, the user 102 may invite the first trusted member 108a for linking the second payment mode to the first transaction card 104 (as shown by arrow 226). The user 102 may invite the first trusted member 108a by using the service application running or is executed on the user device 106. The user device 106 then communicates an invitation to the trusted member device 202 (as shown by arrow 228).

The trusted member device 202 receives the invitation and presents the invitation to the first trusted member 108a. The first trusted member 108a may accept or decline the invitation. In a non-limiting example, it is assumed that the first trusted member 108a accepts the invitation from the user 102. For accepting the invitation, the first trusted member 108a is required to submit the payment mode details of a corresponding payment mode. Thus, the first trusted member 108a submits the payment mode details of the second payment mode (for example, the second transaction card) (as shown by arrow 230). The trusted member device 202 communicates the payment mode details submitted by the first trusted member 108a to the VAS server 110 (as shown by arrow 232). Based on the payment mode details, the VAS server 110 determines whether the second transaction card has the same payment network as the first transaction card 104. In a scenario where the second transaction card has a different payment network from the first transaction card 104, the VAS server 110 determines whether the user 102 has provided consent for cross-network linking. If the user 102 has not provided consent for cross-network linking, the VAS server 110 requests the first trusted member 108a to provide payment mode details of a payment mode that has the same payment network as the first transaction card 104. If the user 102 has provided consent for cross-network linking or the second transaction card has the same payment network as the first transaction card 104, the VAS server 110 generates an authorization request for a $0 transaction from the second transaction card.

The VAS server 110 transmits the authorization request to an issuer server (for example, the issuer server 118) associated with an issuer of the second transaction card for validating the second transaction card (as shown by arrow 234). The issuer server 118 receives the authorization request and validates the $0 transaction when the payment mode details of the second transaction card are valid (as shown by arrow 236). The issuer server 118 transmits an authorization response to the issuer server 118 indicating that the second transaction card is valid, and thus the $0 transaction is authorized (as shown by arrow 238). Based on the authorization response, the VAS server 110 links the second transaction card to the first transaction card 104 and stores the payment mode details of the second transaction card in the corresponding memory (as shown by arrow 240). In one embodiment, the VAS server 110 may assign a unique identifier to the second transaction card for referring the second transaction card. The VAS server 110 further communicates the assigned unique identifier to the user 102 and the first trusted member 108a. In another embodiment, the second transaction card may be assigned the unique identifier by the first trusted member 108a. The VAS server 110 further stores the unique identifier assigned to the second transaction card in the memory of the VAS server 110.

Similarly, the VAS server 110 links the payment modes of other trusted members 108b and 108c who accept the invitation from the user 102. In one embodiment, the user 102 may invite as many trusted members as the user 102 wants for linking their payment modes to the first transaction card 104. In another embodiment, the VAS server 110 may set an upper limit (for example, five) to a count of trusted members that the user 102 may invite. In one exemplary scenario, the VAS server 110 may store the payment mode details of all payment modes that are linked to the payment modes registered with the VAS server 110 in the form of another tabular database (for example, a second database 310 of FIG. 3B).

In another embodiment, the user 102 may link another payment mode, issued to the user 102, to the first transaction card 104, without deviating from the scope of the invention. Thus, the user 102 may initiate an on-behalf transaction using the first transaction card 104 that is registered with the VAS server 110 and user's other payment mode that is linked to the first transaction card 104 may be charged with a transaction amount of the on-behalf transaction. Though the first transaction card 104 and the second transaction card are shown to be associated with same issuer in FIG. 2, it will be understood by those of ordinary skill in the art that the first transaction card 104 and the second transaction card may have different issuers, without deviating from the scope of the invention.

FIG. 3B is a Table that illustrates the second database 310 maintained at the VAS server 110, in accordance with an embodiment of the present invention. The second database 310 stores the payment mode details of payment modes that are linked to the registered payment modes.

The second database 310 includes the registered payment mode column 302, a linked payment mode column 312, a unique identifier column 314, and an expiry date column 316. The linked payment mode column 312 includes payment mode details of payment modes that are linked to the payment modes registered with the VAS server 110. For example, the linked payment mode column 312 may include transaction card numbers of transaction cards and/or wallet ids of the digital wallets that are linked to the registered payment modes of the first database 300. The unique identifier column 314 includes the unique identifiers assigned to the payment modes that are linked to the registered payment modes of the first database 300. The expiry date column 316 includes expiry dates of the payment modes that are linked to the registered payment modes of the first database 300.

In one exemplary scenario, the second database 310 is shown to include third through fifth rows 318-322. The third row 318 indicates that the first transaction card 104 of the user 102 “5xxx xxxx xxxx 1658” is registered and linked to the second transaction card “5xxx xxxx xxxx 4321” of the first trusted member 108a. The third row 318 further indicates that the second transaction card is assigned a unique identifier “John Doe” and has an expiry date of “03/28”. The fourth row 320 indicates that the first transaction card 104 “5xxx xxxx xxxx 1658” is further linked to the third transaction card “4xxx xxxx xxxx 5650” of the second trusted member 108b. The fourth row 320 further indicates that the third transaction card is assigned a unique identifier “Jane Doe” and has an expiry date of “11/34”. Likewise, the fifth row 322 indicates that another registered transaction card of another user “5xxx xxxx xxxx 9870” is linked to another transaction card “5xxx xxxx xxxx 7879” of a corresponding trusted member. The fifth row 322 further indicates that the transaction card “5xxx xxxx xxxx 7879” is assigned a unique identifier “Janice” and has an expiry date of “09/21”. As illustrated in cross-network linking column 304 of the first database 300, cross-network linking is enabled for the registered first transaction card 104 “5xxx xxxx xxxx 1658”. Thus, the payment modes (e.g., the second and third transaction cards) that are linked to the first transaction card 104 may be associated with any payment network. Cross-network linking is disabled for the registered transaction card “5xxx xxxx xxxx 9870”, thus the payment mode (e.g., the transaction card “5xxx xxxx xxxx 7879”) that is linked to the transaction card “5xxx xxxx xxxx 9870” has to be associated with the same payment network as the transaction card “5xxx xxxx xxxx 9870”.

It will be apparent to a person of ordinary skill in the art that the first and second databases 300 and 310 are shown for illustrative purpose and should not be construed to limit the scope of the invention. The transaction card numbers, the unique identifiers, and the expiry dates illustrated in the first and second databases 300 and 310 are mere examples. In another embodiment, the second database 310 may include an additional column for storing authentication parameters associated with the linked payment modes in the linked payment mode column 312. The authentication parameters may be stored in an encrypted format and may be provided by the corresponding trusted members.

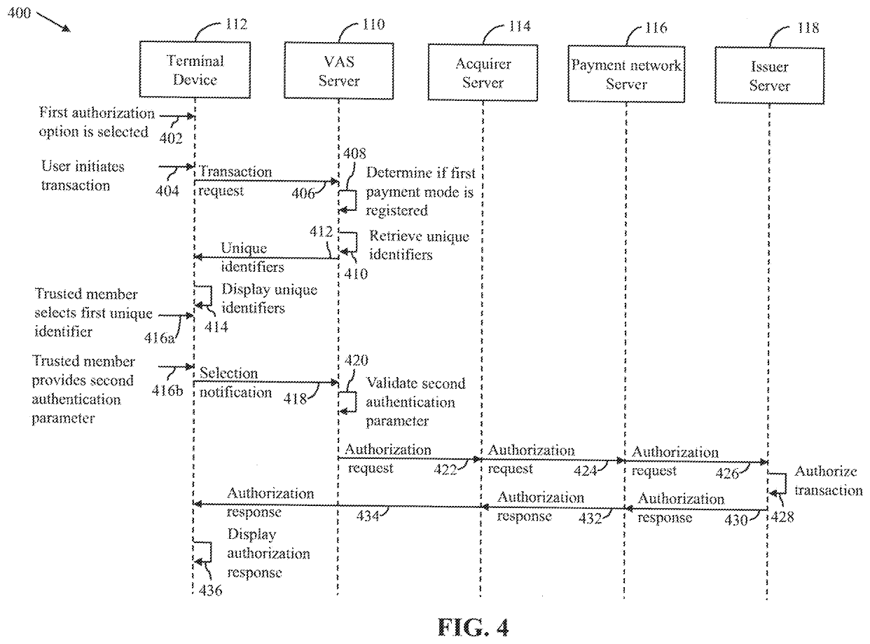

FIG. 4 is a process flow diagram 400 that illustrates an exemplary scenario for facilitating transactions, in accordance with an embodiment of the present invention. The process flow diagram 400 involves the VAS server 110, the terminal device 112, the acquirer server 114, the payment network server 116, and the issuer server 118.

The terminal device 112 renders the graphical interface for presenting the first and second authorization options. The first authorization option offers the value-added service provided by the VAS server 110. The first authorization option is indicative of initiating the transaction by way of a payment mode and charging a transaction amount to a different payment mode that is linked to the payment mode used for initiating the transaction. The second authorization option is the conventional authorization in which the transaction amount is charged to the payment mode used for initiating the transaction. Since the user 102 wants to initiate a transaction on behalf of the first trusted member 108a, the first authorization option is selected (as shown by arrow 402).

The transaction is initiated by the user 102 at the terminal device 112 for a first transaction amount (e.g. $200) (as shown by arrow 404). The user 102 may initiate the transaction using the first payment mode of the user 102 that is registered for the value-added service offered by the VAS server 110. In a non-limiting example, it is assumed that the first payment mode is the first transaction card 104. However, in other embodiments, the user 102 may use the first digital wallet to initiate the transaction. For initiating the transaction, the user 102 provides transaction details of the transaction and a first authentication parameter associated with the first transaction card 104 through the terminal device 112. The transaction details include the first transaction amount, a transaction date, a transaction time, payment mode details of the first transaction card 104, or the like. The first authentication parameter may correspond to a one-time password, a personal identification number, an alphanumeric password, or biometric information (such as fingerprint, retina scan, faceprint, or the like) of the user 102.

The terminal device 112 communicates a transaction request for the transaction to the VAS server 110 (as shown by arrow 406). The transaction request includes the transaction details and the first authentication parameter. Based on the transaction request, the VAS server 110 determines whether the first transaction card 104 (i.e., the first payment mode) used for initiating the transaction is registered for the value-added service (as shown by arrow 408). For determining whether the first transaction card 104 is registered, the VAS server 110 looks up the first database 300 stored in the memory of the VAS server 110. If the first transaction card 104 is determined to be registered for the value-added service, the VAS server 110 looks up the second database 310 to retrieve the unique identifiers of the payment modes that are linked to the first transaction card 104 (as shown by arrow 410). The VAS server 110 further communicates the retrieved unique identifiers to the terminal device 112 (as shown by arrow 412). The terminal device 112 displays the received unique identifiers to the user 102 through the graphical interface (as shown by arrow 414). The first trusted member 108a, for whom the transaction is initiated, selects the first unique identifier from the displayed unique identifiers (as shown by arrow 416a). The first unique identifier has been already assigned to the second payment mode (e.g., the second transaction card) of the first trusted member 108a that is linked to the first transaction card 104 as described in the forgoing description of FIG. 2. The first trusted member 108a further provides a second authentication parameter associated with the second transaction card (as shown by arrow 416b). The terminal device 112 communicates the selection notification indicating the selection of the first unique identifier to the VAS server 110 (as shown by arrow 418). The selection notification includes the second authentication parameter provided by the first trusted member 108a. The VAS server 110 validates the second authentication parameter (as shown by arrow 420). When the VAS server 110 determines that the second authentication parameter is valid, the VAS server 110 generates the authorization request based on the second authentication parameter for initiating the authorization of the transaction. The VAS server 110 communicates the authorization request to the acquirer server 114 (as shown by arrow 422).

The acquirer server 114 receives the authorization request from the VAS server 110 and identifies a payment network that corresponds to the transaction, as known by those skilled in the art. The acquirer server 114 communicates the authorization request to the payment network server 116 of the identified payment network (as shown by arrow 424). The payment network server 116 receives the authorization request and identifies the issuer that corresponds to the transaction, as known by those skilled in the art. Once the issuer is identified, the payment network server 116 communicates the authorization request to the issuer server 118 of the identified issuer (as shown by arrow 426). The issuer server 118 verifies the second authentication parameter and approves the transaction based on the successful verification of the second authentication parameter. The issuer server 118 generates the authorization response indicating the approval of the transaction (as shown by arrow 428). The issuer server 118 further communicates the authorization response to the payment network server 116 (as shown by arrow 430). The payment network server 116 receives the authorization response and communicates the received authorization response to the acquirer server 114 (as shown by arrow 432). The acquirer server 114 communicates the authorization response to the terminal device 112 (as shown by arrow 434). By way of the authorization response, the terminal device 112 is notified whether the transaction has been approved or declined by the issuer server 118. The terminal device 112 displays on the rendered graphical interface a message to indicate whether the transaction is approved or declined (as shown by arrow 436). In a non-limiting example, it is assumed that the transaction is approved. In such a scenario, the transaction amount (i.e., $200) of the transaction is charged to the second transaction card of the first trusted member 108a.

In one embodiment, the issuer server 118 may not approve the transaction due to insufficient balance in the second transaction card or poor network connectivity. In such a scenario, the transaction may be declined and the authorization response generated by the issuer server 118 indicates that the transaction is declined. In one exemplary scenario, the VAS server 110 may determine that the second authentication parameter included in the selection notification is invalid. In such a scenario, the VAS server 110 declines the transaction, and notifies the user 102 and the first trusted member 108a.

In one exemplary scenario, the user 102 may not have sufficient balance in the first transaction card 104 that is registered with the VAS server 110 and may want to purchase a product from a merchant or withdraw cash at an ATM. In such a scenario, the user 102 may initiate a transaction using the first transaction card 104, and may select a unique identifier assigned to another payment mode of the user 102 that is linked to the first transaction card 104 and has sufficient balance. Thus, the other payment mode of the user 102 is charged with the transaction amount of the transaction.

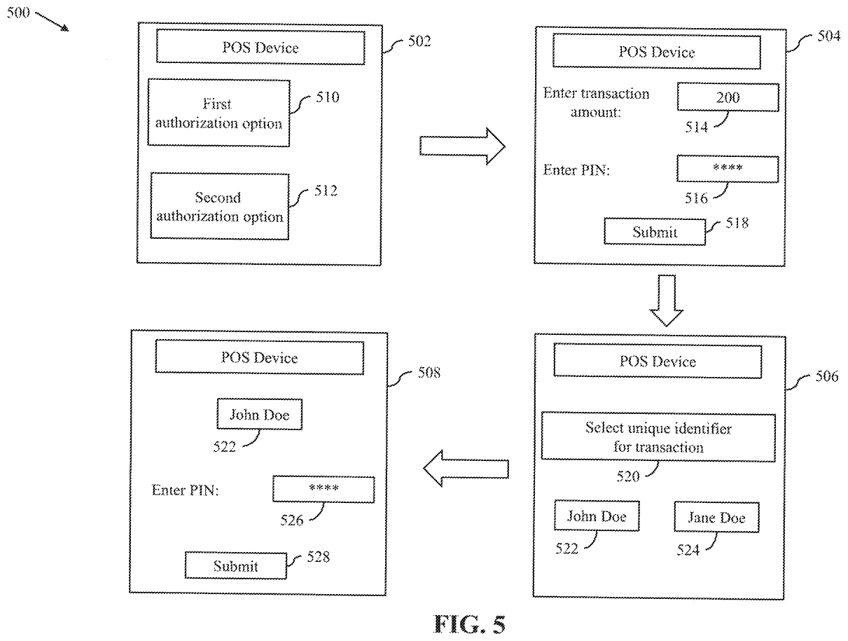

FIG. 5 is an exemplary scenario 500 that illustrates first through fourth user interface (UI) screens 502, 504, 506, and 508 rendered on the terminal device 112 for enabling the users to initiate transactions and avail the value-added service offered by the VAS server 110, in accordance with an embodiment of the present invention. In a non-limiting example, the terminal device 112 is shown to be a POS device in FIG. 5.

When the user 102 interacts with the terminal device 112 for initiating the transaction, the first UI screen 502 is rendered on a display (not shown) of the terminal device 112. The first UI screen 502 may prompt the user 102 to select one of a ‘first authorization option’ button 510 and a ‘second authorization option’ button 512. The ‘first authorization option’ button 510 represents the first authorization option for performing the transaction and the ‘second authorization option’ button 512 represents the second authorization option for performing the transaction. When the user 102 selects or activates the ‘second authorization option’ button 512, the transaction is processed based on a conventional four-party model or a conventional three-party model as known by those skilled in the art. When the user 102 selects the ‘first authorization option’ button 510, the terminal device 112 may render the second UI screen 504.

The second UI screen 504 may display a first input box 514 that allows the user 102 to enter the transaction amount (e.g., $200) for the transaction. In one embodiment, the second UI screen 504 may display a second input box 516 that allows the user 102 to enter the first authentication parameter (e.g., a one-time password, a personal identification number, and/or an alphanumeric password) associated with the first payment mode (e.g., the first transaction card 104 or the first digital wallet) of the user 102. In another embodiment, when the terminal device 112 conducts biometric authentication by way of a fingerprint, a voiceprint, a faceprint, retina scan, and/or the like, the second UI screen 504 may not display the second input box 516. The second UI screen 504 may further display a first submit button 518, which is selectable by the user 102. When the user 102 provides the transaction amount and the first authentication parameter in the first and second input boxes 514 and 516, respectively, and selects or activates the first submit button 518, the terminal device 112 may communicate the transaction request to the VAS server 110. After the VAS server 110 validates the transaction request, the terminal device 112 may receive unique identifiers (e.g., “John Doe” and “Jane Doe”) of the payment modes that are linked to the first payment mode. After receiving the unique identifiers, the terminal device 112 may render the third UI screen 506.

The third UI screen 506 displays a message in a second text box 520 for prompting the user 102 to select one unique identifier from the displayed unique identifiers. The unique identifiers (e.g., “John Doe” and “Jane Doe”) are displayed by way of first and second buttons 522 and 524 on the third UI screen 506. The first trusted member 108a may select one of the first or second button 522 or 524 that corresponds to the second payment mode of the first trusted member 108a. In a non-limiting example, it is assumed that the first button 522 representing the unique identifier “John Doe” is selected. Based on the selection of the unique identifier “John Doe”, the terminal device 112 may render the fourth UI screen 508.

The fourth UI screen 508 may display the unique identifier “John Doe” selected by the first trusted member 108a and a third input box 526. The third input box 526 allows the first trusted member 108a to enter the second authentication parameter (e.g., a one-time password, a personal identification number, and/or an alphanumeric password) of the second payment mode. In one embodiment, when the terminal device 112 may conduct biometric authentication by way of a fingerprint, a voiceprint, a faceprint, retina scan, and/or the like, the fourth UI screen 508 may not display the third input box 526. The fourth UI screen 508 may further display a second submit button 528 which is selectable by the first trusted member 108a. When the first trusted member 108a provides the second authentication parameter and selects or activates the second submit button 528, the terminal device 112 may communicate the selection notification that indicates the selection of the unique identifier and includes the second authentication parameter to the VAS server 110.

After the VAS server 110 validates the second authentication parameter, the VAS server 110 may communicate the authorization request to the acquirer server 114. The terminal device 112 may further receive the authorization response from the acquirer server 114. Based on the authorization response, the terminal device 112 may display another message indicating whether the transaction is approved or declined on a fifth UI screen (not shown).

It will be apparent to a person of ordinary skill in the art that the scope of the terminal device 112 is not limited to a POS device, in other embodiments, the terminal device 112 may be an ATM. In such a scenario, the user 102 may select the first authorization option at the ATM for withdrawing cash (e.g., $500) on behalf of the first trusted member 108a. The method for facilitating the transaction at the ATM is similar to the facilitation of the transaction at the POS device.

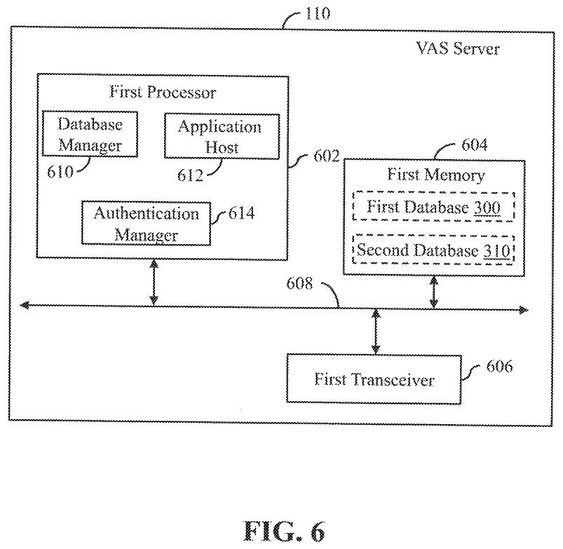

FIG. 6 is a block diagram that illustrates the VAS server 110, in accordance with an embodiment of the present invention. The VAS server 110 includes a first processor 602, a first memory 604, and a first transceiver 606. The first processor 602, the first memory 604, and the first transceiver 606 communicate with each other by way of a first communication bus 608.

The first processor 602 includes suitable logic, circuitry, interfaces, and/or codes, executable by the circuitry, for processing transactions performed by way of various registered payment modes. Examples of the first processor 602 may include, but are not limited to, an application specific integrated circuit (ASIC) processor, a reduced instruction set computer (RISC) processor, a complex instruction set computer (CISC) processor, a field programmable gate array (FPGA), or the like. The first processor 602 includes a database manager 610, an application host 612, and an authentication manager 614.

The database manager 610 is configured to manage the first and second databases 300 and 310 stored in the first memory 604. The database manager 610 may execute various database management operations (such as, storing data, updating stored data, or deleting the data) for managing the first and second databases 300 and 310. The database manager 610 stores the payment mode details of the registered payment modes and the linked payment modes in the first and second databases 300 and 310. The database manager 610 further retrieves the unique identifiers from the second database 310 based on the transaction request received from the terminal device 112.

The application host 612 hosts the service application running on the user device 106 and the trusted member device 202. By way of the service application, the application host 612 allows the user 102 to register the corresponding first payment mode for the value-added service. The application host 612 further allows the trusted members 108 to link their respective payment modes to the registered first payment mode based on the invitation received from the user 102.

The authentication manager 614 requests the issuer server 118 to validate the first payment mode of the user 102 before registering the first payment mode. The authentication manager 614 further communicates the authorization requests for $0 transactions to the issuer server 118 for validating the payment mode details of the payment modes of the trusted members 108. The authentication manager 614 looks up the first and second databases 300 and 310 for validating the second authentication parameter submitted by the first trusted member 108a through the terminal device 112.

The first memory 604 includes suitable logic, circuitry, interfaces, and/or codes, executable by the circuitry, for storing the first and second databases 300 and 310 (as described in FIGS. 3A and 3B). Examples of the first memory 604 may include, but are not limited to, a random-access memory (RAM), a read-only memory (ROM), a removable storage drive, a hard-disk drive (HDD), a flash memory, a solid-state memory, or the like. It will be apparent to a person of ordinary skill in the art that the scope of the invention is not limited to realizing the first memory 604 in the VAS server 110, as described herein. In another embodiment, the first memory 604 may be realized in form of a database server or a cloud storage working in conjunction with the VAS server 110, without departing from the scope of the invention.

The first transceiver 606 transmits and receives data over the communication network 120 using one or more communication protocols. The first transceiver 606 transmits various requests and messages to the terminal device 112 and the acquirer server 114. For example, the first transceiver 606 may transmit the unique identifiers to the terminal device 112. The first transceiver 606 may transmit the authorization request to the acquirer server 114. The first transceiver 606 receives various requests and messages from the terminal device 112. For example, the first transceiver 606 may receive the transaction request from the terminal device 112. Examples of the first transceiver 606 may include, but are not limited to, an antenna, a radio frequency transceiver, a wireless transceiver, a Bluetooth transceiver, an Ethernet port, a universal serial bus (USB) port, or any other device configured to transmit and receive data.

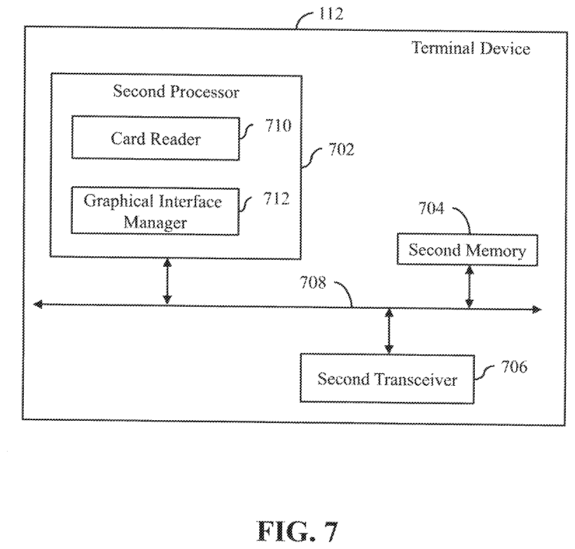

FIG. 7 is a block diagram that illustrates the terminal device 112, in accordance with an embodiment of the present invention. The terminal device 112 includes a second processor 702, a second memory 704, and a second transceiver 706. The second processor 702, the second memory 704, and the second transceiver 706 communicate with each other by way of a second communication bus 708.

The second processor 702 includes suitable logic, circuitry, interfaces, and/or codes, executable by the circuitry, to process transactions initiated at the terminal device 112. The second processor 702 may communicate the transaction request for the transaction to the VAS server 110. For example, when the user 102 selects the first authorization option for the transaction, the second processor 702 communicates the transaction request, including the transaction details of the transaction and the first authentication parameter of the first payment mode, to the VAS server 110. The second processor 702 further communicates the selection notification to the VAS server 110. Examples of the second processor 702 may include, but are not limited to, an ASIC processor, a RISC processor, a CISC processor, a FPGA, or the like. The second processor 702 includes a card reader 712 and an interface manager 714.

The card reader 712 may include suitable logic, circuitry, interfaces, and/or codes, executable by the circuitry, to read the payment mode details of the first transaction card 104. For example, when the user 102 uses the first transaction card 104 at the terminal device 112 to initiate the transaction, the card reader 712 reads the card details of the first transaction card 104.

The interface manager 714 renders the first through fourth UI screens 502-508 (as described in FIG. 5) on the display of the terminal device 112 based on instructions received from the second processor 702. For example, when the user 102 initiates the transaction, the interface manager 714 renders the first UI screen 502 on the display of the terminal device 112. When the ‘first authorization option’ button 510 is selected by the user 102, the interface manager 714 further renders the second UI screen 504 on the display of the terminal device 112. The second processor 702 communicates the transaction request to the VAS server 110. The interface manager 714 renders the third UI screen 506 for displaying the unique identifiers received from the VAS server 110. The interface manager 714 further renders the fourth UI screen 508 to display the selected unique identifier and the third input box 526 to allow the first trusted member 108a to enter the second authentication parameter as described in the foregoing description of FIG. 5.

The second memory 704 includes suitable logic, circuitry, interfaces, and/or codes, executable by the circuitry, for storing the transaction request of the transaction. Examples of the second memory 704 may include, but are not limited to, a RAM, a ROM, a removable storage drive, a HDD, a flash memory, a solid-state memory, or the like. It will be apparent to a person skilled in the art that the scope of the invention is not limited to realizing the second memory 704 in the terminal device 112, as described herein. In another embodiment, the second memory 704 may be realized in form of a database server or a cloud storage working in conjunction with the terminal device 112, without departing from the scope of the invention.

The second transceiver 706 transmits and receives data over the communication network 120 using one or more communication protocols. The second transceiver 706 transmits various requests and messages to the VAS server 110. For example, the second transceiver 706 transmits the transaction request for the transaction to the VAS server 110. The second transceiver 706 further transmits the selection notification to the VAS server 110. The second transceiver 706 receives various requests and messages from the VAS server 110 and the acquirer server 114. For example, the second transceiver 706 receives the unique identifiers from the VAS server 110. The second transceiver 706 further receives the authorization response of the transaction from the acquirer server 114. Examples of the second transceiver 706 may include, but are not limited to, an antenna, a radio frequency transceiver, a wireless transceiver, a Bluetooth transceiver, an Ethernet port, a USB port, or any other device configured to transmit and receive data.

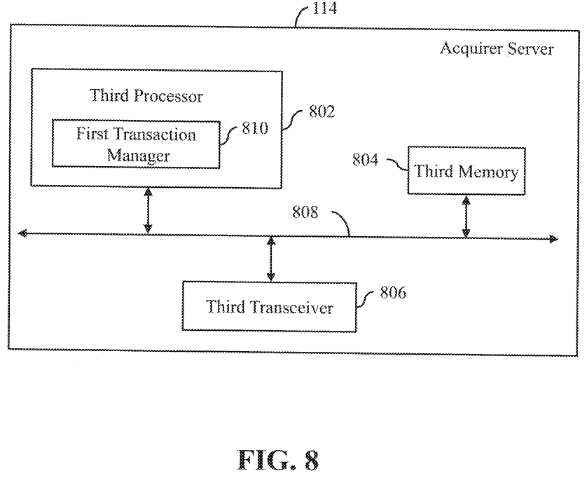

FIG. 8 is a block diagram that illustrates the acquirer server 114, in accordance with an embodiment of the present invention. The acquirer server 114 includes a third processor 802, a third memory 804, and a third transceiver 806. The third processor 802, the third memory 804, and the third transceiver 806 communicate with each other by way of a third communication bus 808.

The third processor 802 includes suitable logic, circuitry, interfaces, and/or codes, executable by the circuitry, for processing transactions performed by way of various payment modes. Examples of the third processor 802 may include, but are not limited to, an ASIC processor, a RISC processor, a CISC processor, a FPGA, or the like. The third processor 802 includes a first transaction manager 810. The first transaction manager 810 identifies a payment network (for example, the payment network server 116) that corresponds to the transaction based on the authorization request received from the VAS server 110 or the terminal device 112.

The third memory 804 includes suitable logic, circuitry, interfaces, and/or codes, executable by the circuitry, for storing the authorization request of the transaction. Examples of the third memory 804 may include, but are not limited to, a RAM, a ROM, a removable storage drive, a HDD, a flash memory, a solid-state memory, or the like. It will be apparent to a person skilled in the art that the scope of the invention is not limited to realizing the third memory 804 in the acquirer server 114, as described herein. In another embodiment, the third memory 804 may be realized in form of a database server or a cloud storage working in conjunction with the acquirer server 114, without departing from the scope of the invention.

The third transceiver 806 transmits and receives data over the communication network 120 using one or more communication protocols. The third transceiver 806 transmits various requests and messages to the terminal device 112 and the payment network server 116. For example, the third transceiver 806 transmits the authorization request to the payment network server 116 for authorizing the transaction. The third transceiver 806 further transmits the authorization response of the transaction to the terminal device 112. The third transceiver 806 receives various requests and messages from the VAS server 110 and the payment network server 116. For example, the third transceiver 806 receives the authorization request from the VAS server 110. The third transceiver 806 further receives the authorization response of the transaction from the payment network server 116. Examples of the third transceiver 806 may include, but are not limited to, an antenna, a radio frequency transceiver, a wireless transceiver, a Bluetooth transceiver, an Ethernet port, a USB port, or any other device configured to transmit and receive data.

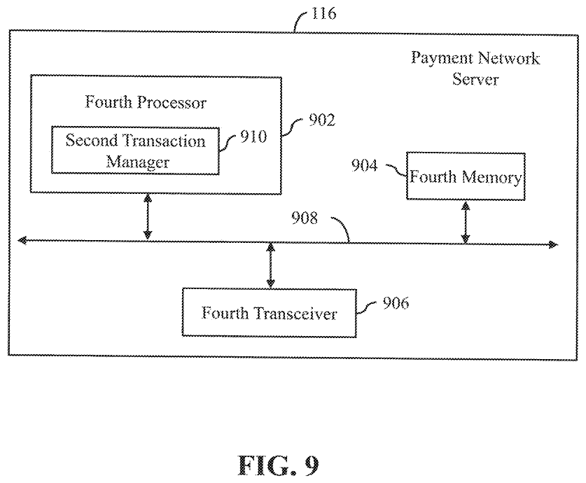

FIG. 9 is a block diagram that illustrates the payment network server 116, in accordance with an embodiment of the present invention. The payment network server 116 includes a fourth processor 902, a fourth memory 904, and a fourth transceiver 906. The fourth processor 902, the fourth memory 904, and the fourth transceiver 906 communicate with each other by way of a fourth communication bus 908.

The fourth processor 902 includes suitable logic, circuitry, interfaces, and/or codes, executable by the circuitry, for processing transactions performed by way of the payment modes. Examples of the fourth processor 902 may include, but are not limited to, an ASIC processor, a RISC processor, a CISC processor, a FPGA, or the like. The fourth processor 902 includes a second transaction manager 910. The second transaction manager 910 identifies an issuer, for example the issuer server 118, that corresponds to the transaction based on the authorization request received from the acquirer server 114.

The fourth memory 904 includes suitable logic, circuitry, interfaces, and/or codes, executable by the circuitry, for storing the authorization requests of various transactions that correspond to the payment network server 116. Examples of the fourth memory 904 may include, but are not limited to, a RAM, a ROM, a removable storage drive, a HDD, a flash memory, a solid-state memory, or the like. It will be apparent to a person skilled in the art that the scope of the invention is not limited to realizing the fourth memory 904 in the payment network server 116, as described herein. In another embodiment, the fourth memory 904 may be realized in form of a database server or a cloud storage working in conjunction with the payment network server 116, without departing from the scope of the invention.

The fourth transceiver 906 transmits and receives data over the communication network 120 using one or more communication protocols. The fourth transceiver 906 transmits various requests and messages to the issuer server 118. For example, the fourth transceiver 906 transmits the authorization request to the issuer server 118 for authorizing the transaction. The fourth transceiver 906 receives various requests and messages from the issuer server 118. For example, the fourth transceiver 906 receives the authorization response from the issuer server 118. Examples of the fourth transceiver 906 may include, but are not limited to, an antenna, a radio frequency transceiver, a wireless transceiver, a Bluetooth transceiver, an Ethernet port, a USB port, or any other device configured to transmit and receive data.

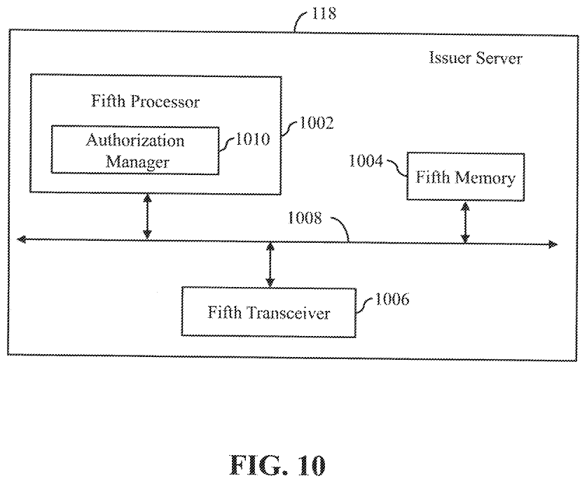

FIG. 10 is a block diagram that illustrates the issuer server 118, in accordance with an embodiment of the present invention. The issuer server 118 includes a fifth processor 1002, a fifth memory 1004, and a fifth transceiver 1006. The fifth processor 1002, the fifth memory 1004, and the fifth transceiver 1006 communicate with each other by way of a fifth communication bus 1008.

The fifth processor 1002 includes suitable logic, circuitry, interfaces, and/or codes, executable by the circuitry for authorizing transactions performed by way of the payment modes. Examples of the fifth processor 1002 may include, but are not limited to, an ASIC processor, a RISC processor, a CISC processor, a FPGA, or the like. The fifth processor 1002 includes an authorization manager 1010. The authorization manager 1010 authorizes the $0 transactions initiated by the VAS server 110 from the payment modes of the trusted members 108. The authorization manager 1010 further authorizes the transaction based on the authorization request received from the payment network server 116. Based on the authorization of the transaction, the authorization manager 1010 may generate the authorization response for the transaction.

The fifth memory 1004 includes suitable logic, circuitry, interfaces, and/or codes, executable by the circuitry, for storing the account profiles of various user accounts that are managed at the issuer server 118. The fifth memory 1004 further stores the authorization requests of various transactions that are associated with the issuer server 118. Examples of the fifth memory 1004 may include, but are not limited to, a RAM, a ROM, a removable storage drive, a HDD, a flash memory, a solid-state memory, or the like. It will be apparent to a person skilled in the art that the scope of the invention is not limited to realizing the fifth memory 1004 in the issuer server 118, as described herein. In another embodiment, the fifth memory 1004 may be realized in form of a database server or a cloud storage working in conjunction with the issuer server 118, without departing from the scope of the invention.

The fifth transceiver 1006 transmits and receives data over the communication network 120 using one or more communication protocols. The fifth transceiver 1006 receives various requests and messages from the VAS server 110 and the payment network server 116. For example, the fifth transceiver 1006 receives the authorization requests for the $0 transaction request from the VAS server 110. The fifth transceiver 1006 further receives the authorization requests from the payment network server 116. The fifth transceiver 1006 transmits various requests and messages to the VAS server 110 and the payment network server 116. For example, the fifth transceiver 1006 transmits the authorization response for the $0 transactions to the VAS server 110. The fifth transceiver 1006 further transmits the authorization responses of the transactions to the payment network server 116. Examples of the fifth transceiver 1006 may include, but are not limited to, an antenna, a radio frequency transceiver, a wireless transceiver, a Bluetooth transceiver, an Ethernet port, a USB port, or any other device configured to transmit and receive data.

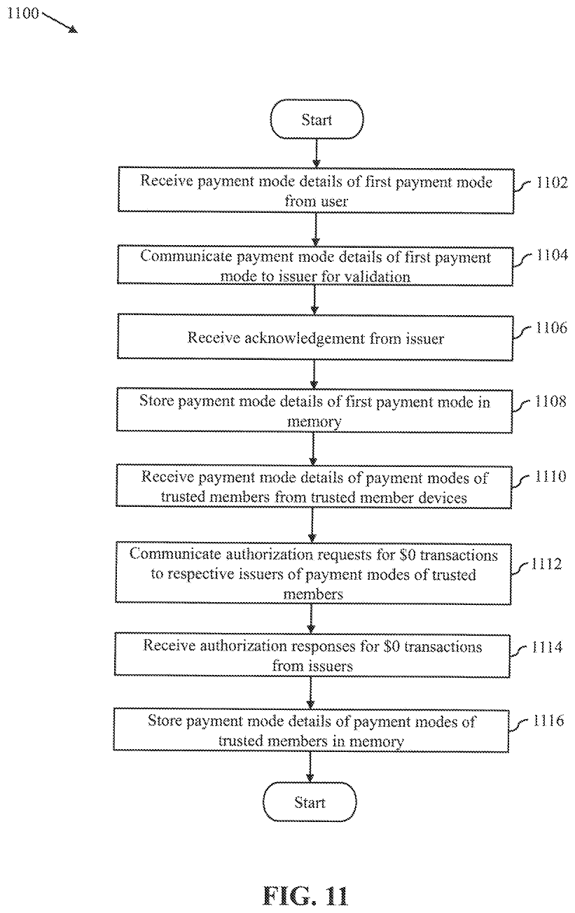

FIG. 11 represents a flow chart 1100 that illustrates a method for registering the users with the VAS server 110, in accordance with an embodiment of the present invention.

At step 1102, the VAS server 110 receives the payment mode details of the first payment mode through the user device 106. At step 1104, the VAS server 110 communicates the payment mode details of the first payment mode to the issuer server 118, associated with the first payment mode, for validation of the first payment mode. The issuer server 118 validates the payment mode details of the first payment mode and communicates the acknowledgement to the VAS server 110. At step 1106, the VAS server 110 receives the acknowledgement indicating the validation of the payment mode details from the issuer server 118. At step 1108, the VAS server 110 stores the payment mode details of the first payment mode in the first database 300. The first database 300 is stored in the first memory 604. After the registration of the user 102, the user 102 may invite the trusted members 108 for linking their corresponding payment modes with the registered first payment mode. At step 1110, the VAS server 110 receives the payment mode details of the payment modes of the trusted members 108 from trusted member devices (e.g., the trusted member device 202). For example, the first trusted member 108a may accept the invitation from the user 102 and provide the payment mode details of the corresponding payment mode to the VAS server 110 using the trusted member device 202. At step 1112, the VAS server 110 communicates authorization requests for $0 transactions to the respective issuers of the payment modes of the trusted members 108. At step 1114, the VAS server 110 receives the authorization responses for the $0 transactions from the issuers (e.g., the issuer server 118). Based on the authorization responses, the VAS server 110 may determine whether the payment modes of the trusted members 108 are valid. At step 1116, the VAS server 110 stores the payment mode details of the payment modes of the trusted members 108 in the second database 310. The second database 310 is stored in the first memory 604.

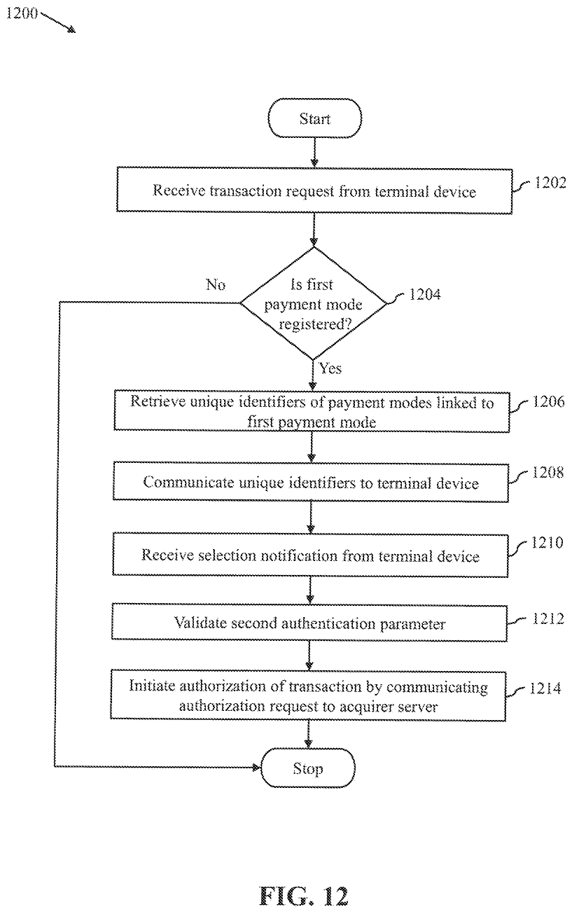

FIG. 12 represents a flow chart 1200 that illustrates a method for facilitating transactions by the VAS server 110, in accordance with an embodiment of the present invention. The terminal device 112 may be utilized by the user 102 to initiate a transaction on behalf of the first trusted member 108a by way of the first payment mode. The user 102 may select the first authorization option for performing the transaction. The terminal device 112 may communicate the transaction request for the transaction to the VAS server 110.

At step 1202, the VAS server 110 receives the transaction request for the transaction initiated by the user 102 at the terminal device 112 using the first payment mode. The transaction request includes the transaction details of the transaction and the first authentication parameter of the first payment mode. At step 1204, the VAS server 110 determines whether the first payment mode is registered for the value-added service. For determining whether the first payment mode is registered, the VAS server 110 looks up the first database 300. If at step 1204, it is determined that the first payment mode is not registered for the value-added service, the transaction is terminated. If at step 1204, it is determined that the first payment mode is registered for the value-added service, step 1206 is performed. At step 1206, the VAS server 110 retrieves the unique identifiers of the payment modes that are linked to the first payment mode from the second database 310.

At step 1208, the VAS server 110 communicates the unique identifiers to the terminal device 112. At step 1210, the VAS server 110 receives the selection notification from the terminal device 112. The selection notification indicates the selection of the first unique identifier of the first trusted member 108a and includes the second authentication parameter of the second payment mode of the first trusted member 108a. At step 1212, the VAS server 110 validates the second authentication parameter. In a non-limiting example, it is assumed that the second authentication parameter is valid. After the validation of the second authentication parameter, the VAS server 110 generates the authorization request based on the second authentication parameter. At step 1214, the VAS server 110 initiates the authorization of the transaction by communicating the authorization request to the acquirer server 114.

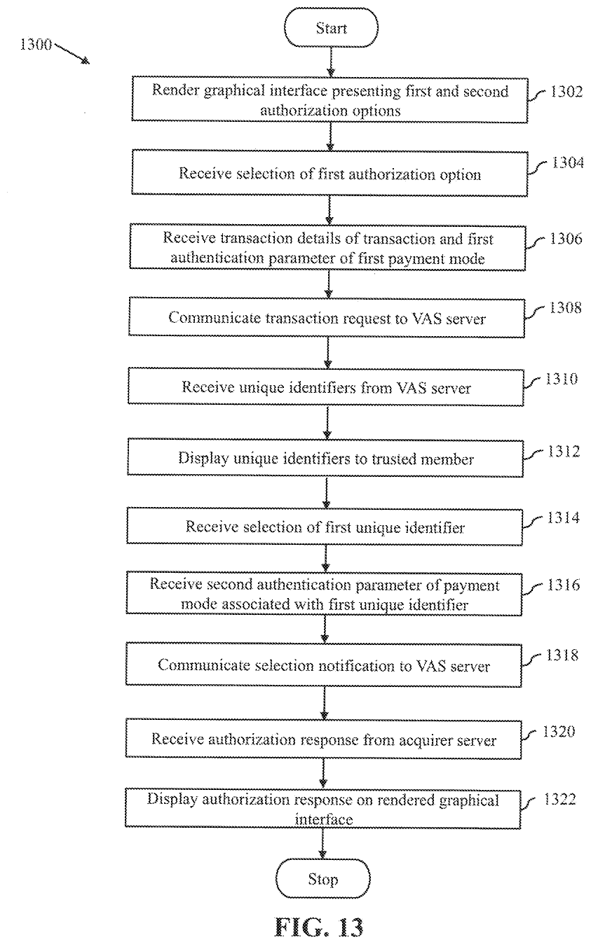

FIG. 13 represents a flow chart 1300 that illustrates a method for facilitating transactions by the terminal device 112, in accordance with an embodiment of the present invention. At step 1302, the terminal device 112 renders the graphical interface for presenting the first and second authorization options. At step 1304, the terminal device 112 receives the selection of the first authorization option. At step 1306, the terminal device 112 receives the transaction details for the transaction initiated by way of the first payment mode and the first authentication parameter of the first payment mode. At step 1308, the terminal device 112 communicates the transaction request to the VAS server 110. At step 1310, the terminal device 112 receives the unique identifiers of the payment modes that are linked to the first payment mode from the VAS server 110. At step 1312, the terminal device 112 displays the received unique identifiers on the rendered graphical interface to the first trusted member 108a.

At step 1314, the terminal device 112 receives the selection of the first unique identifier. At step 1316, the terminal device 112 receives the second authentication parameter of the second payment mode associated with the selected first unique identifier. At step 1318, the terminal device 112 communicates the selection notification to the VAS server 110. Based on the validation of the second authentication parameter, the VAS server 110 initiates the authorization of the transaction by communicating the authorization request for the transaction to the issuer server 118. The issuer server 118 generates the authorization response. At step 1320, the terminal device 112 receives the authorization response from the acquirer server 114. At step 1322, the terminal device 112 displays the authorization response on the rendered graphical interface.

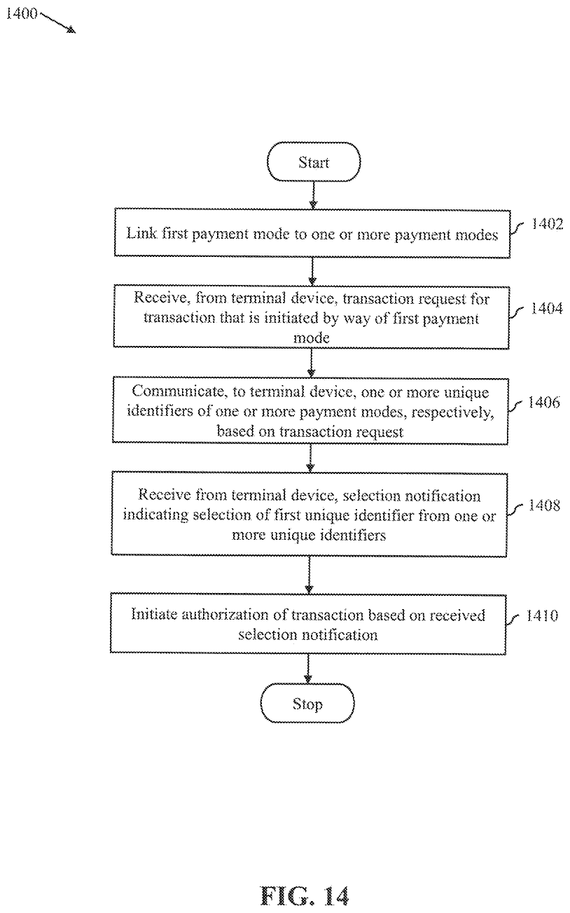

FIG. 14 represents a high-level flow chart 1400 that illustrates a method for facilitating transactions, in accordance with an embodiment of the present invention. At step 1402, the VAS server 110 links the first payment mode to one or more payment modes. At step 1404, the VAS server 110 receives the transaction request for the transaction initiated by way of the first payment mode from the terminal device 112. At step 1406, the VAS server 110 communicates the one or more unique identifiers of the one or more payment modes, respectively, to the terminal device 112. At step 1408, the VAS server 110 receives a selection notification indicating the selection of the first unique identifier from the one or more unique identifiers. The first unique identifier is associated with the second payment mode that is linked to the first payment mode. At step 1410, the VAS server 110 initiates the authorization of the transaction based on the received selection notification. The second payment mode is charged with the transaction amount of the transaction when the transaction is authorized.

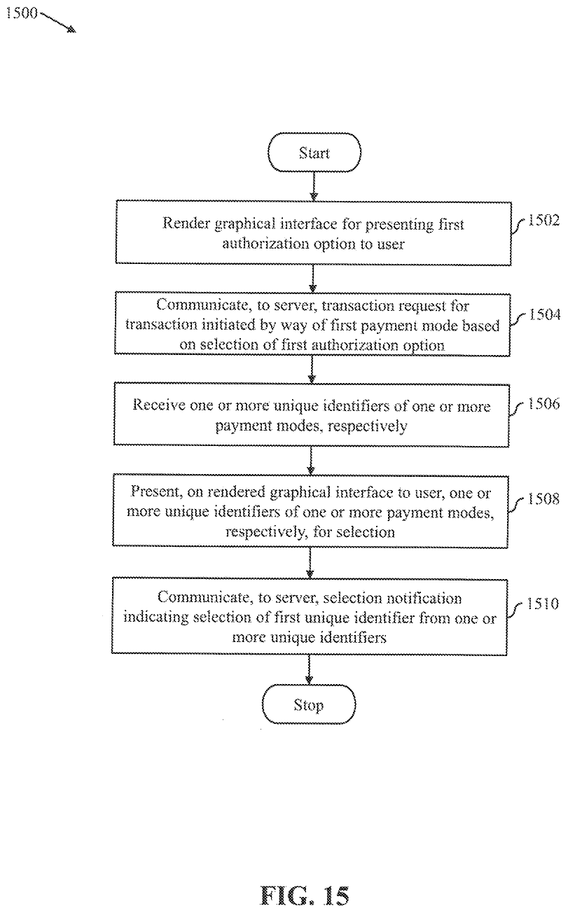

FIG. 15 represents a high-level flow chart 1500 that illustrates a method for facilitating transactions, in accordance with an embodiment of the present invention. At step 1502, the terminal device 112 renders the graphical interface (for example, the first UI screen 502) for presenting the first authorization option (for example, the ‘first authorization option’ button 510) to the user 102. The first authorization option is indicative of initiating the transaction by way of the first payment mode and charging the transaction amount of the transaction to a different payment mode that is linked to the first payment mode. At step 1504, the terminal device 112 communicates the transaction request for the transaction initiated by way of the first payment mode to the VAS server 110. The transaction request is communicated based on the selection of the first authorization option. At step 1506, the terminal device 112 receives one or more unique identifiers of one or more payment modes, respectively. The one or more payment modes are linked to the first payment mode. At step 1508, the terminal device 112 presents, on the rendered graphical interface, the one or more unique identifiers of the one or more payment modes for selection. At step 1510, the terminal device 112 communicates the selection notification, indicating the selection of the first unique identifier from the one or more unique identifiers, to the VAS server 110. The first unique identifier is associated with the second payment mode that is linked to the first payment mode and the transaction amount is charged to the second payment mode, when the transaction is authorized.

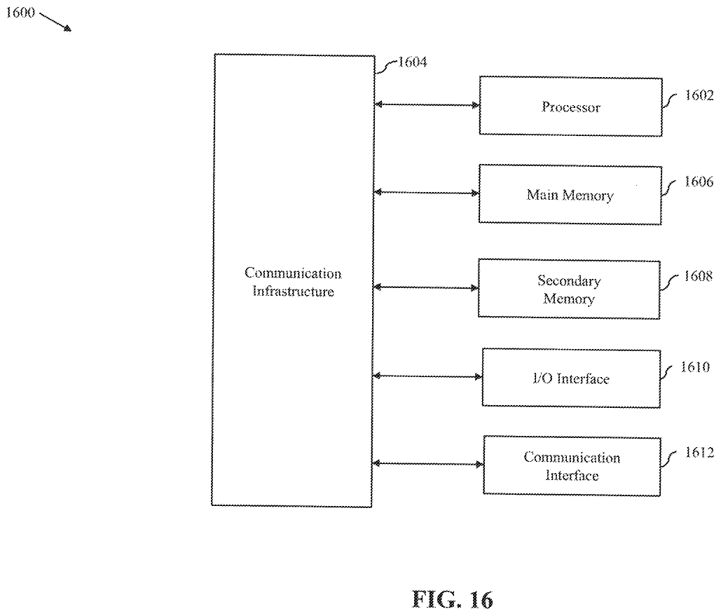

FIG. 16 is a block diagram that illustrates system architecture of a computer system 1600, in accordance with an embodiment of the present invention. An embodiment of present invention, or portions thereof, may be implemented as computer readable code on the computer system 1600. In one example, the VAS server 110, the acquirer server 114, the payment network server 116, and the issuer server 118 may be implemented in the computer system 1600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 11-15.

The computer system 1600 includes a processor 1602 that may be a special-purpose or a general-purpose processing device. The processor 1602 may be a single processor, multiple processors, or combinations thereof. The processor 1602 may have one or more processor cores. In one example, the processor 1602 is an octa-core processor. Further, the processor 1602 may be connected to a communication infrastructure 1604, such as a bus, message queue, multi-core message-passing scheme, and the like. The computer system 1600 may further include a main memory 1606 and a secondary memory 1608. Examples of the main memory 1606 may include RAM, ROM, and the like. The secondary memory 1608 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1600 further includes an input/output (I/O) interface 1610 and a communication interface 1612. The I/O interface 1610 includes various input and output devices that are configured to communicate with the processor 1602. Examples of the input devices may include a keyboard, a mouse, a joystick, a touchscreen, a microphone, and the like. Examples, of the output devices may include a display screen, a speaker, headphones, and the like. The communication interface 1612 may be configured to allow data to be transferred between the computer system 1600 and various devices that are communicatively coupled to the computer system 1600. Examples of the communication interface 1612 may include a modem, a network interface, i.e., an Ethernet card, a communications port, and the like. Data transferred via the communication interface 1612 may correspond to signals, such as electronic, electromagnetic, optical, or other signals as will be apparent to a person skilled in the art. The signals may travel via a communications channel (not shown) which may be configured to transmit the signals to devices that are communicatively coupled to the computer system 1600. Examples of the communications channel may include, but are not limited to, cable, fiber optics, a phone line, a cellular phone link, a radio frequency link, and the like.

Computer program medium and computer usable medium may refer to memories, such as the main memory 1606 and the secondary memory 1608, which may be a semiconductor memory such as a DRAM. These computer program mediums may provide data that enables the computer system 1600 to implement the methods illustrated in FIGS. 11-15. In an embodiment, the present invention is implemented using a computer implemented application, the computer implemented application may be stored in a computer program product and loaded into the computer system 1600 using the removable storage drive or the hard disc drive in the secondary memory 1608, the I/O interface 1610, or communication interface 1612.

A person of ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 1602 and a memory such as the main memory 1606 and the secondary memory 1608 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Technological improvements in the VAS server 110 enable the VAS server 110 to offer the value-added service. By registering the first payment mode for the value-added service, the user 102 is enabled to initiate a transaction on behalf of the trusted members 108 by using the registered first payment mode. Thus, the VAS server 110 enables various trusted members, such as the trusted members 108, to carry out in the absence of their respective payment modes. The method and system of the present invention increases business for the merchants as well as results in more revenue to the acquirers, the payment networks, and the issuers as the number of transactions are increased.

Techniques consistent with the present invention provide, among other features, systems and methods for facilitating transactions. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. A method for facilitating transactions, the method comprising:
linking, by a server, a first payment mode to one or more payment modes;
receiving, by the server from a terminal device, a transaction request for a transaction initiated by way of the first payment mode;
communicating, by the server to the terminal device, one or more unique identifiers of the one or more payment modes, respectively, based on the transaction request;
receiving, by the server from the terminal device, a selection notification indicating a selection of a first unique identifier from the one or more unique identifiers, wherein the first unique identifier is associated with a second payment mode that is linked to the first payment mode; and
initiating, by the server, an authorization of the transaction based on the received selection notification, wherein the second payment mode is charged with a transaction amount of the transaction when the transaction is authorized.

2. The method of claim 1, further comprising:
receiving, by the server, one or more details of the one or more payment modes from one or more trusted members associated with the one or more payment modes, wherein the one or more trusted members communicate the one or more details to the server based on an invite from a user of the first payment mode; and
validating, by the server, the one or more details of the one or more payment modes, wherein the one or more payment modes are linked to the first payment mode based on the validation of the one or more details.

3. The method of claim 2, further comprising storing, by the server in a memory, the one or more unique identifiers and the one or more details, of the one or more payment modes linked to the first payment mode.

4. The method of claim 3, further comprising retrieving, by the server from the memory, the one or more unique identifiers based on the received transaction request, for communicating to the terminal device.

5. The method of claim 1, wherein the transaction request includes at least one of the transaction amount, a transaction date, a transaction time, information of the first payment mode, and a first authentication parameter associated with the first payment mode.

6. The method of claim 1, wherein the selection notification includes a second authentication parameter associated with the second payment mode.

7. The method of claim 1, wherein the server communicates the one or more unique identifiers to the terminal device based on a selection of a first authorization option presented on a graphical interface rendered by the terminal device, and wherein the first authorization option is indicative of initiating the transaction by way of the first payment mode and charging the transaction amount to a different payment mode that is linked to the first payment mode.

8. The method of claim 1, further comprising communicating, by the server to an acquirer, an authorization request for initiating the authorization of the transaction, wherein the authorization request is generated based on the selection notification.

9. The method of claim 1, wherein each of the first payment mode and the one or more payment modes corresponds to one of a transaction card or a digital wallet.

10. A system for facilitating transactions, the system comprising:
a server that is configured to:
link a first payment mode to one or more payment modes,
receive, from a terminal device, a transaction request for a transaction initiated by way of the first payment mode,
communicate, to the terminal device, one or more unique identifiers of the one or more payment modes, respectively, based on the transaction request,
receive, from the terminal device, a selection notification indicating a selection of a first unique identifier from the one or more unique identifiers, wherein the first unique identifier is associated with a second payment mode that is linked to the first payment mode, and
initiate an authorization of the transaction based on the received selection notification, wherein the second payment mode is charged with a transaction amount of the transaction when the transaction is authorized.

11. The system of claim 10, wherein the server is further configured to:
receive one or more details of the one or more payment modes from one or more trusted members associated with the one or more payment modes, wherein the one or more trusted members communicate the one or more details to the server based on an invite from a user of the first payment mode, and
validate the one or more details of the one or more payment modes, wherein the one or more payment modes are linked to the first payment mode based on the validation of the one or more details.

12. The system of claim 11, wherein the server is further configured to store in a memory, the one or more unique identifiers and the one or more details, of the one or more payment modes linked to the first payment mode.

13. The system of claim 12, wherein the server is further configured to retrieve from the memory, the one or more unique identifiers based on the received transaction request, for communicating to the terminal device.

14. The system of claim 10, wherein the transaction request includes at least one of the transaction amount, a transaction date, a transaction time, information of the first payment mode, and a first authentication parameter associated with the first payment mode.

15. The system of claim 10, wherein the selection notification includes a second authentication parameter associated with the second payment mode.

16. The system of claim 10, wherein the server communicates the one or more unique identifiers to the terminal device based on a selection of a first authorization option presented on a graphical interface rendered by the terminal device, and wherein the first authorization option is indicative of initiating the transaction by way of the first payment mode and charging the transaction amount to a different payment mode that is linked to the first payment mode.

17. The system of claim 10, wherein the server is further configured to communicate to an acquirer, an authorization request for initiating the authorization of the transaction, wherein the authorization request is generated based on the selection notification.

18. The system of claim 10, wherein each of the first payment mode and the one or more payment modes corresponds to one of a transaction card or a digital wallet.

19. A method for facilitating transactions, the method comprising:
rendering, by a terminal device, a graphical interface for presenting a first authorization option to a user, wherein the first authorization option is indicative of initiating a transaction by way of a first payment mode and charging a transaction amount of the transaction to a different payment mode that is linked to the first payment mode;
communicating, by the terminal device to a server, a transaction request for the transaction that is initiated by way of the first payment mode, wherein the transaction request is communicated based on a selection of the first authorization option;
receiving, by the terminal device from the server, one or more unique identifiers of one or more payment modes, respectively, wherein the one or more payment modes are linked to the first payment mode;
presenting, by the terminal device on the rendered graphical interface, the one or more unique identifiers for selection; and
communicating, by the terminal device to the server, a selection notification indicating a selection of a first unique identifier from the one or more unique identifiers, wherein the first unique identifier is associated with a second payment mode that is linked to the first payment mode, and wherein the second payment mode is charged with the transaction amount when the transaction is authorized.

20. The method of claim 19, wherein each of the first payment mode and the one or more payment modes corresponds to one of a transaction card or a digital wallet.
